(19) United States
(12) Patent Application Publication
(10) Pub. No.: US 2007/0212501 A1
(43) Pub. Date: Sep. 13, 2007

(54) Thermal-activated beverage containers and holders

(76) Inventors: Wynn Wolfe, Arcadia, CA (US); Dennis Scott Juett, Sierra Madre, CA (US)

Correspondence Address: CHRISTIE, PARKER & HALE, LLP, PO BOX 7068, PASADENA, CA, 91109-7068, US

(21) Appl. No.: 11/371,066

(22) Filed: Mar. 7, 2006

(51) Int. Cl. B31B 45/00

(52) U.S. Cl. 428/34.1; 428/99

(57) ABSTRACT

A beverage container holder has a dual-function graphics pattern. The holder comprises a tubular liner having at least a first opening for receiving a beverage container, the liner having an inside surface and an outside surface, a layer of insulating material on the inside surface of the liner, a graphics pattern applied to the outer surface of the liner, and a thermochromic ink composition on the outer surface of the liner forming at least a portion of the graphics pattern. The thermochromic ink composition has (1) a first state that matches or masks a portion of the graphics pattern at room temperature, (2) a second state that reacts to thermal change at a temperature above room temperature from a hot medium disposed in the container to reveal a first phase of the graphics pattern, and (3) a third state that reacts to a thermal change at a temperature below room temperature from a cold medium disposed in the container to reveal a second phase of the graphics pattern. In another embodiment certain color-change visual effects are produced by images formed with blended thermochromic ink compositions that change from one color at room temperature to a first color at a higher temperature and to a different second color at a lower temperature.

### FIELD OF THE INVENTION

This invention relates to graphics images, messages, or other artwork applied to containers for holding beverages and to sleeve-like container holders. The various graphics images applied, according to principles of the invention, are temperature-activated, using various patterns of thermochromic ink applied to the graphics patterns in a hide-and-reveal format.

### BACKGROUND

Containers for holding beverages can have thermal-activated thermochromic images applied to the outer surface of the container. Thermochromic materials, such as thermochromic ink layers, can be applied as image layers that hide a non-thermochromic or permanent image. Application of heat can cause the thermochromic layers to reach their transition temperatures at which they change state from opaque colors to transparent or colorless, for example. Different thermochromic materials (as specified by their manufacturers) can have different transition temperatures. Thermochromic materials are disclosed in U.S. Pat. Nos. 5,202,677 to Parker et al. and 5,805,245 to Davis and 5,223,958 to Berry, which are incorporated herein by reference. Standard drinking containers having thermochromic displays for hiding and revealing an underlying graphics design are disclosed on my website at www.originalls.com.

In addition to providing graphics images on containers for holding beverages, various graphics designs, messages, or other artwork can be applied to container holders. Such container holders are available in the well known tapered sleeve-like structure adapted for thermally spacing the hands of users from the temperatures transmitted from high temperature contents in the container, for example. Such container holders are disclosed, for example, in U.S. Pat. No. 5,205,473 to Coffin, et al.

### SUMMARY OF THE INVENTION

Briefly, one embodiment of the invention comprises a beverage container holder having a dual-function graphics pattern. The holder comprises a tubular liner having at least a first opening for receiving a beverage container and a layer of insulating material on the inside surface of the liner. A graphics pattern is applied to the outer surface of the liner. A thermochromic ink composition on the outer surface of the liner provides at least a portion of the graphics pattern.

The thermochromic ink composition has (1) a first state that matches or masks a portion of the graphics pattern at room temperature, (2) a second state that reacts to thermal change at a temperature above room temperature from a hot medium disposed in the container to reveal a first phase of the graphics pattern, and (3) a third state that reacts to a thermal change at a temperature below room temperature from a cold medium disposed in the container to reveal a second phase of the graphics pattern.

In another form of the invention, the dual-function thermochromic ink graphics pattern can be applied to a flexible strip or the like which is carried on a beverage container and reacts to temperature changes from hot or cold beverages in the container.

In another embodiment, dual-function graphics patterns can be produced using one or more blended thermochromic ink compositions which change from one color at room temperature to a different first color at higher temperatures and to a different second color at lower temperatures.

Thus, the present invention provides a thermochromic ink-activated image display that can be applied to containers or container holders. The image display can be in the form of a dual-function pattern which disguises or hides surprise graphics elements in which one function or the other will become apparent via thermochromic color-changing ink patterns activated when subjected to either hot or cold temperature changes. In one embodiment, the thermochromic ink pattern can be applied to either a container or a container holder so that the color-changing ink patterns are activated to produce the surprise graphics when the container is filled with either a hot or a cold beverage.

### BRIEF DESCRIPTION OF THE DRAWINGS

FIG. 1 is a perspective view illustrating a beverage container having a container holder with a graphics design and thermochromic ink pattern applied according to principles of this invention.

FIG. 2 is an elevational view of the beverage container holder in a flat form illustrating graphics images applied to the container holder and having a thermochromic ink composition in a first thermally-non-activated state.

FIG. 3 is an elevational view of the holder in flat form similar to FIG. 2, but showing the thermochromic ink composition in a first thermally-activated state.

FIG. 4 is an elevational view similar to FIGS. 2 and 3 but showing the thermochromic ink composition in a second thermally-activated state.

FIG. 5 is an elevational view showing an alternative graphics image having a thermochromic ink composition in a first thermally-non-activated state.

FIG. 6 is an elevational view of the thermochromic ink image similar to FIG. 5 but showing the thermochromic ink composition in a first thermally activated state.

FIG. 7 is an elevational view similar to FIGS. 5 and 6 but showing the thermochromic ink composition in a second thermally activated state.

### DETAILED DESCRIPTION

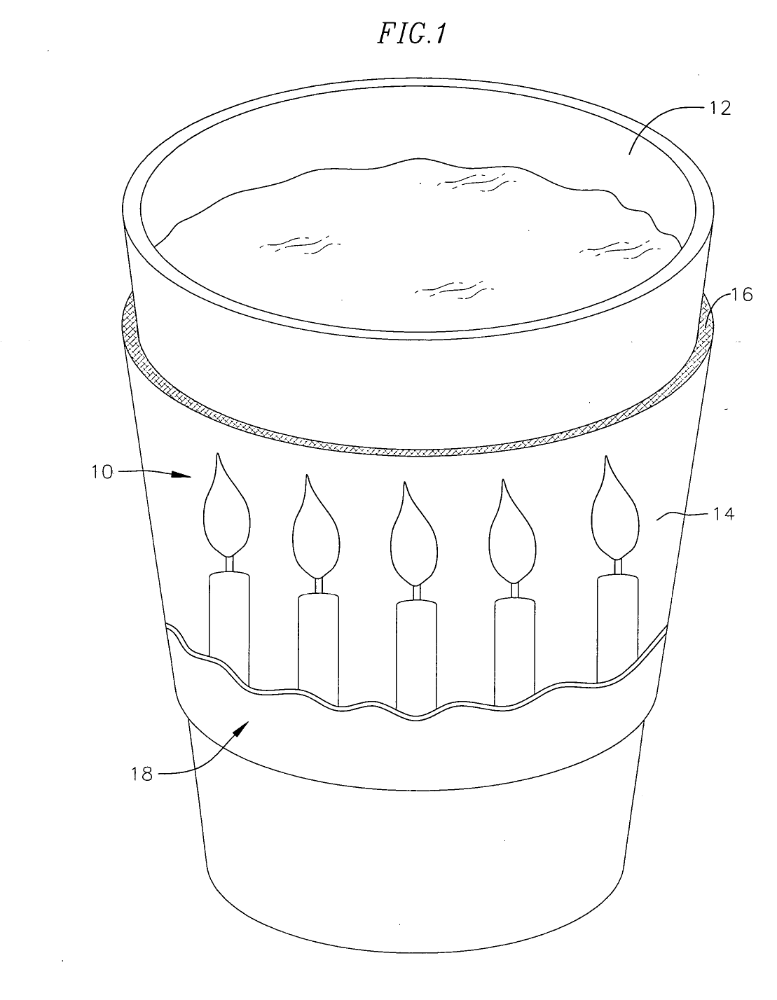

FIG. 1 shows a beverage container holder 10 positioned on a container 12 for holding either a hot beverage or a cold beverage. The illustrated beverage container holder is of generally tubular configuration, having a tapered structure which opens wider in an upward direction in the well-known manner. The beverage holder is preferably made from a flexible liner 14 having an insulating layer 16 disposed around its inside surface for contact with the outer surface of the container.

The liner 14 is preferably made from a thin flexible material in flat sheet form. The outside face of the liner is preferably made from an ink receptive material on which decorative images can be printed, such as by silk screening, to form permanent decorative images on the exterior of the liner. A preferred liner material is an essentially non-porous, thin sheet of a cellulosic material such as paper, or a material having an inner surface coating of a plastic insulating material.

The insulating layer 16 as shown in FIG. 1 is made from a flexible corrugated material for thermally spacing the hands of a user from the temperatures transmitted from the contents in the container. The illustrated embodiment is simply an example of an insulating material that can be used with the invention. In this instance, the corrugated material would be a sinusoidal flexible strip that can be attached to the inside of the liner 14 by an adhesive material, for example. Other insulating structures also can be used without departing from the scope of the invention. These can include a fluted, quilted or pillowed structure (not shown) that provides an irregular profile on the liner to provide insulating air in a separation space between the pillowed liner and the container. Also, certain cellulosic materials may be used for the insulating layer; or an insulated layer may be on the inside of a laminated liner that can also include on its outer surface an ink receptive polymeric sheet material.

A graphics image pattern 18 is applied to the outer surface of the liner. The graphics image pattern can comprise decorative images, a message, or other visual effects. Certain portions of the graphics pattern are covered by or formed by one or more layers or formulated blends of thermochromic ink to provide various hide-and-reveal effects when the thermochromic ink layer or layers are activated by selected temperature changes transmitted from hot or cold temperature contents in the container. The temperature changes are transmitted through the liner to the thermochromic ink patterns on the outer surface of the liner.

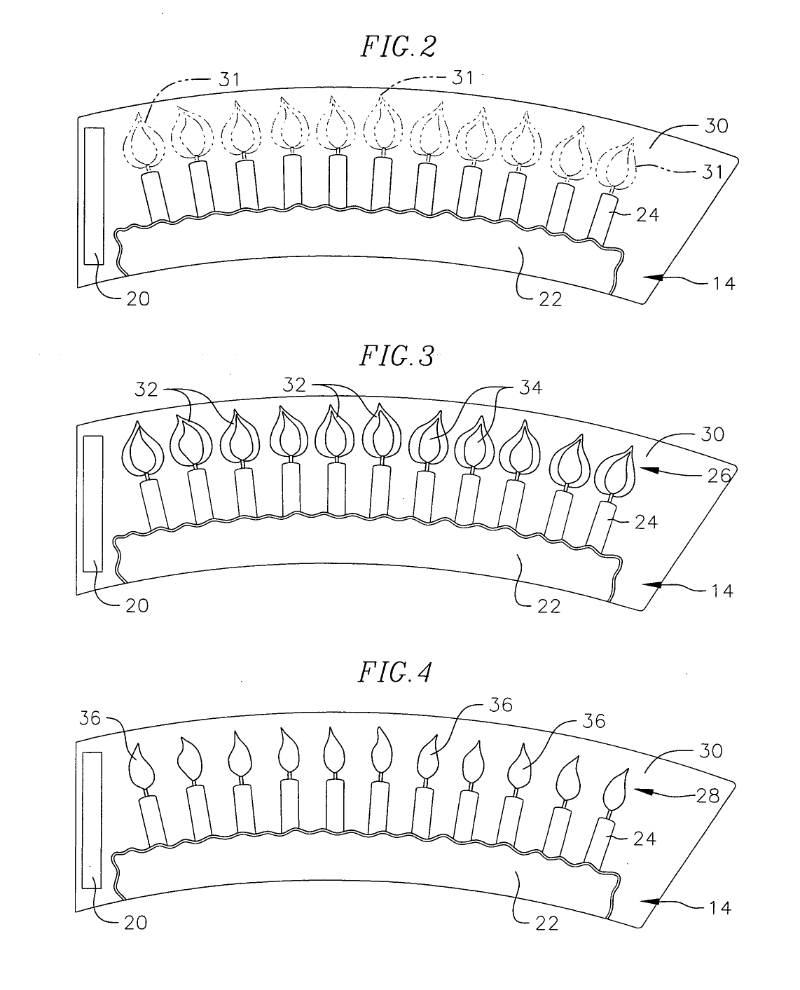

FIGS. 2-4 illustrate graphics image patterns that are shown by way of example to illustrate principles of this invention. In this instance, the liner 14 is shown in flat form prior to its being wrapped or folded into its tubular configuration (as illustrated in FIG. 1). The flat form liner includes a region 20 at one edge that contains an adhesive or other bonding material for fastening the opposed edges to form the finished tubular shape.

The graphics image pattern on the liner 14 in FIGS. 2-4 comprises an image of a birthday cake 22 having candles 24 to illustrate various stages of the hide-and-reveal effects provided by the invention. These portions of the printed design are permanent, non-temperature-activated elements of the image pattern. The image pattern illustrated in FIGS. 2-4 comprises a dual-function thermal-activated pattern in which the flames on the candles are matched or hidden from view at room temperature. The flames 26 illustrated above the candles are revealed in a first color pattern when heat-activated; and the flames 28 above the candles are revealed in a second color pattern in response to sensing a cold temperature. The flames are made from one or more layers of thermochromic ink or blends thereof as described below.

The various effects shown by the hide-and-reveal stages illustrated in FIGS. 2-4 are produced by a thermochromic ink composition on the outer surface of the liner which is part of the graphics pattern applied to the liner. In this embodiment, the thermochromic ink composition has (1) a first state that matches or masks a portion of the hide-and-reveal graphics pattern at room temperature, (2) a second state that reacts to thermal change at a temperature above room temperature (e.g., from a hot medium disposed in the container) to reveal a first thermal-activated phase of the graphics pattern, and (3) a third state that reacts to a thermal change at a temperature below room temperature (e.g., from a cold medium disposed in the container) to reveal a second thermal-activated phase of the graphics pattern. In the illustrated embodiment, the selected portion of the graphics pattern revealed by the third state is a different portion of or a different color in the graphics pattern when compared with the portion or color of the graphics pattern revealed by the second state.

The hide-and-reveal thermochromic layers will now be described. The flames are virtually hidden from view in FIG. 2. One technique for hiding the flames as shown in FIG. 2 is to provide the liner with a permanent background color that corresponds to the room temperature color of a heat-activated thermochromic ink that forms one or more portions of the flames. For instance, if the background 30 has a permanent color such as orange, the candle flames 31 which are unperceived (as illustrated in FIG. 2) can have inner and outer portions which are formed by various combinations of thermochromic ink that make the candle flames invisible at room temperature. In one embodiment, an outside portion 32 of the flames is formed by an ink which is orange at room temperature and an inside portion 34 of the flames is covered by a thermochromic ink layer which is transparent at room temperature so that the permanent orange background shows through. This renders the flames on the candles unperceived (invisible) at room temperature.

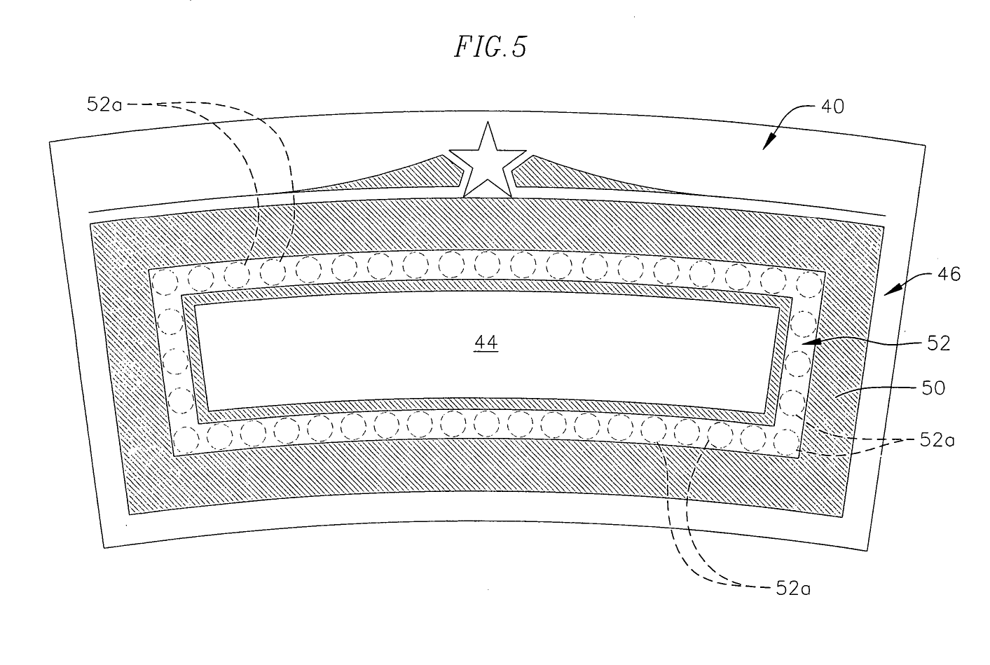

FIG. 3 illustrates the change in state when the container holder is slipped onto a container holding a hot drink. The increase in temperature transmitted through the liner thermally activates thermochromic ink layers that form portions of the graphics representing the candle flames. In the illustrated embodiment of FIG. 3, the outer portions 32 of the flames are thermally activated to change color from orange to yellow, for example. Central portions 34 of the flames can be formed by a different and clear thermochromic ink that is dormant and colorless at the same high temperature.

FIG. 4 illustrates the change in state when the container holder is slipped onto a container holding a cold drink. The decrease in temperature transmitted through the liner thermally activates the cold-triggered thermochromic ink layers. The candle flames 36 are revealed when sensing a cold temperature. In this embodiment, flames 36 are revealed when their thermochromic ink layers are cold-triggered to change color, for example, from transparent at room temperature to red at the cold temperature. The cold-triggered thermal ink is dormant, invisible and non-functional at room temperature (FIG. 2) and at elevated temperatures (FIG. 3). The thermal inks which cover the outside portions 32 of the flames revealed in the high temperature state of FIG. 3 reverts to their original orange color at the cold temperature. Thus, the ink which turns red when cold-triggered covers the orange-colored central portions 34 of the flames, but is clear at room temperature, activated to red at cold temperature, but dormant at high temperature, allowing the orange color below it to show through.

The layers of thermochromic ink described for the various embodiments of the invention are selected to be triggered by hot or cold temperature changes at selected transition temperatures. For example, room temperatures can be in the range of about 60° to 100° F. Thermochromic inks for producing selected optical effects can be chosen from inks providing either an opaque color layer or which are transparent at room temperature.

Different thermochromic inks can be selected to produce this high temperature or cold temperature effects. Thermochromic inks that change from color to color or color to transparent or transparent to color can be selected to be thermal-activated at high temperatures above about 140° F. or at low temperatures below about 55° F., for example.

Thermochromic inks useful for this invention are available from CTI (Chromatic Technologies, Inc.), Colorado Springs, Colo.

In an alternative form of the invention, blended thermochromic inks may be used. For instance, the dual function effects of the present invention may be carried out using a three-phase blended thermochromic ink composition. Thermochromic inks that may be blended include a color-to-color composition, that changes from one color at a relatively lower temperature to another color at a relatively higher temperature, and a transparent-to-color composition that changes from colorless at a relatively higher temperature to a color at a relatively lower temperature.

In one embodiment, images produced by such blended thermochromic ink compositions can change from orange at room temperature to yellow at high temperature and from orange at room temperature to red at low temperature, for example. Such a blended ink composition can be made from 75% component (1) and 25% component (2), where component (1) is red at lower temperature and colorless at higher temperature, and component (2) is orange at lower temperature and yellow at higher temperature, for example. The blended materials can be used to control the hue of the orange color that exists at room temperature.

Use of other similar blends of thermochromic inks can produce similar dual function image effects by changing from one color at room temperature to a first different color at higher temperature and to a second different color at low temperature. Preferably the second color is different from the first color. Various optical effects can be produced by such blended compositions.

In one embodiment, thermochromic inks supplied by CTI, mentioned above, are screen printing inks applied to a white or light-colored background so as to produce maximum color intensity.

In another form of the invention the dual-function thermochromic ink design can be applied to a thermal beverage container in the form of a tumbler. In this instance, the container can include an annular open space between a transparent outer wall and an inner wall of the container. The dual-function thermal-activated graphics patterns can be applied to a flexible ink-receptive strip (similar to FIGS. 2-4) and positioned in the annular space. Hot or cold temperature changes transmitted through the inner wall can trigger the thermochromic ink layers to produce the desired hot or cold activated effects which are visible through the transparent outer wall.

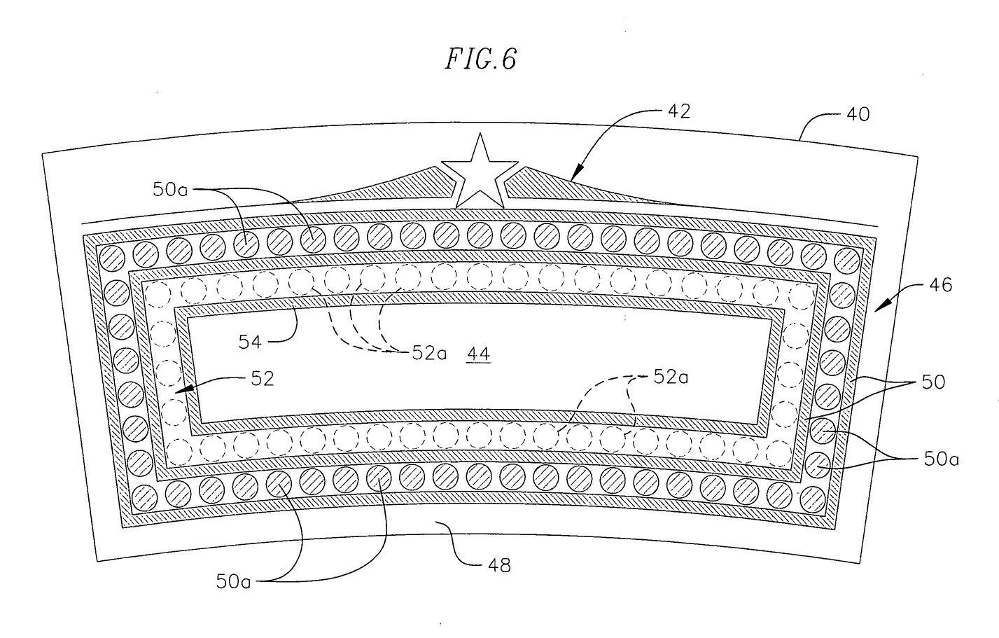

FIGS. 5 to 7 illustrate an alternative embodiment of the invention in which a cup holder or ink receptive strip 40 contains permanent graphics images combined with different combinations of heat-activated and cold-activated thermochromic ink layers to produce different hide-and-reveal effects at hot and cold temperatures. In this instance, the holder or flexible strip 40 can have permanent graphics in the form of a marquee 42 with a central region 44 on which a user's name can be written or printed (with permanent or erasable nonpermanent ink for example). An outer border region 46 can include a space 48 where a permanent message (not shown) may be printed that relates to the subject of the graphics pattern. An example would be “See your name in lights!”

In addition to permanent image structures, portions of the marquee are formed by thermochromic ink regions. These include an outer border region 50 and an intermediate border region 52. A permanent inner border region is shown at 54.

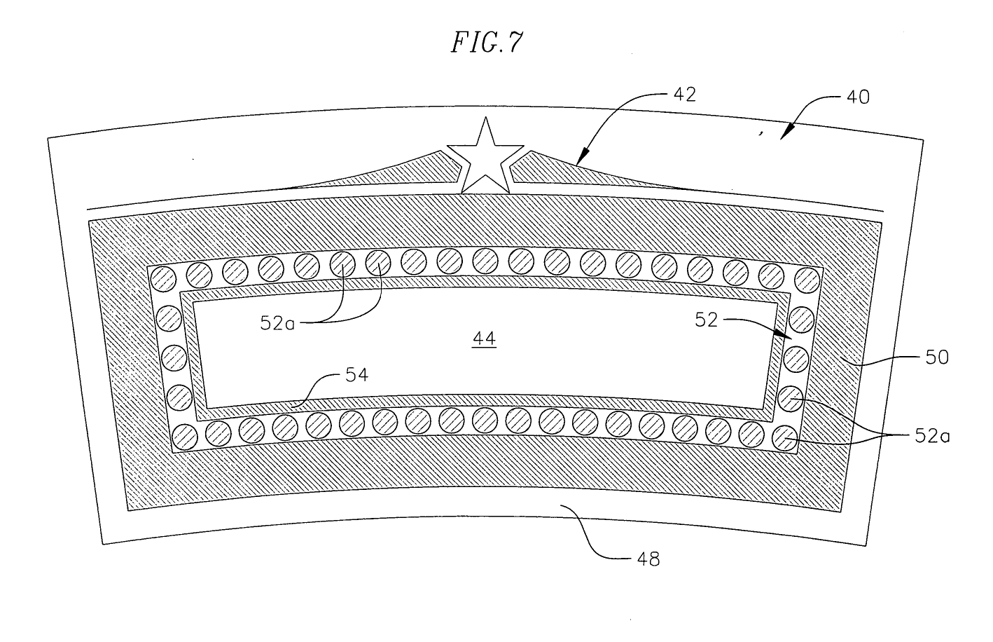

FIG. 5 illustrates a room temperature embodiment in which the outer border region comprises a continuous opaque layer 50 of thermochromic ink. In one embodiment, the opaque layer can be a dark color such as blue or black that optionally matches the color of the inner border 54. The thermochromic ink layer 50 is opaque at room temperature and masks permanent images 50a printed below it as illustrated in FIG. 6. The room temperature embodiment of FIG. 5 also includes layers 52a of thermochromic ink images in the intermediate region 52 of the marquee. These layers 52a are colorless or dormant at room temperature but are revealed as illustrated in FIG. 7. The portions of the intermediate border region not containing the layers of thermochromic ink are a permanent background color that matches the colorless state of the images 52a. Therefore, at room temperature the intermediate border region 52 is a continuous unitary color. As a result, no marquee images 50a or 52a are revealed at room temperature. (The thermochromic ink images 50a, which are masked by the thermochromic ink layer forming the outer border 50, are not shown in FIG. 5.)

FIG. 6 illustrates an embodiment in which the liner or holder is applied to a container at high temperatures. In this instance, portions of the thermochromic ink that form the outer border 50 turn from opaque to colorless at high temperature, and the permanent images 50a, which were masked by the outer border at room temperature, are revealed in a color such as yellow at high temperature. In the illustrated embodiment, the images 50a are shown as a series of spaced apart lights that encircle the inner region 44 of the marquee. At high temperatures, the thermochromic image layers 52a in the intermediate region remain colorless.

FIG. 7 illustrates an embodiment in which the liner or holder is applied to a container at low temperatures. In this instance, the thermochromic ink layer forming the outer border 50 remains opaque and masks the images 50a. And the thermochromic ink image layers 52a, which were colorless or dormant at room temperature and high temperature, are revealed as an opaque color such as magenta. Typically, the images 52a would be a different color from the colors in the row of lights in the intermediate region. In the illustrated cold temperature embodiment, the images 52a represent a second series of spaced apart lights encircling the inner portion 44 of the marquee.

As a result, when the holder or liner is applied to a container at high temperature, the lights encircling the marquee are revealed and turn to a color different from the row of lights that are revealed at cold temperature.

The invention has been described with reference to examples of a hot or cold temperature-activated hide-and-reveal decorative image pattern; but other patterns illustrating other artwork or design subject matter can be used without departing from the scope of the invention.

What is claimed is:

1. A beverage container holder having a dual-function graphics pattern, the holder comprising a tubular liner having at least a first opening for receiving a beverage container, the liner having an inside surface and an outside surface, a layer of insulating material on the inside surface of the liner, a graphics pattern applied to the outer surface of the liner, and a thermochromic ink composition on the outer surface of the liner covering or providing at least a portion of the graphics pattern, the thermochromic ink composition having (1) a first state that matches or masks a portion of the graphics pattern at room temperature, (2) a second state that reacts to thermal change at a temperature above room temperature from a hot medium disposed in the container to reveal a first phase of the graphics pattern, and (3) a third state that reacts to a thermal change at a temperature below room temperature from a cold medium disposed in the container to reveal a second phase of the graphics pattern.

2. Apparatus according to claim 1 in which the selected phase of the graphics pattern revealed by the third state is a different portion of or a different color or the same color in the graphics pattern when compared with the phase of the graphics pattern revealed by the second state.

3. Apparatus according to claim 1 in which the graphics pattern includes a permanent section applied to one portion of the sleeve, uncovered or made apparent by the thermochromic ink, and in which a second hide and reveal portion of the graphics pattern is covered or matched by the thermochromic ink.

4. Apparatus according to claim 1 in which the liner has a background color, and in which the thermochromic ink composition in its first state comprises a color-to-color thermochromic ink that in the first state matches the background color to render the covered or matched portion of the graphics pattern unapparent or hidden at room temperature.

5. Apparatus according to claim 4 in which the color-to-color thermochromic ink is heat activated to change to a different color in the second state or remains dormant or unchanged in the third state.

6. Apparatus according to claim 1 in which the thermochromic ink composition includes a color-to-color or color-to-clear thermochromic ink layer that becomes thermally activated to change to a selected color when sensing the temperature of a hot medium in the container, while maintaining an adjacent cold activated thermochromic ink layer dormant at the higher temperature.

7. Apparatus according to claim 1 in which the thermochromic ink composition includes a color-to-color or clear-to-color thermochromic ink layer that becomes thermally activated to change to a selected color when sensing the temperature of a cold medium in the container, while maintaining an adjacent heat-activated thermochromic ink layer dormant at the lower temperature.

8. Apparatus according to claim 1 in which the insulating layer is an irregularly shaped structure formed on the liner.

9. A container shaped generally as a thermal tumbler and having an interior wall structure separated from an outer wall structure by an open space between the inner and outer wall structures, in which the outer wall structure is at least partially transparent, and a graphics display device contained in the open space visible through the transparent portion of the outer wall structure, the graphics display device comprising a flexible liner having an outside surface, a graphics pattern applied to the outer surface of the liner, and a thermochromic ink composition on the outer surface of the liner covering or providing at least a portion of the graphics pattern, the thermochromic ink composition having (1) a first state that matches or masks a portion of the graphics pattern at room temperature, (2) a second state that reacts to thermal change at a temperature above room temperature from a hot medium disposed in the container to reveal a first phase of the graphics pattern, and (3) a third state that reacts to a thermal change at a temperature below room temperature from a cold medium disposed in the container to reveal a second phase of the graphics pattern.

10. A dual-function display for use on an article that can be subjected to higher temperatures above room temperature and to lower temperatures below room temperature, for producing different color-change visual effects in response to the sensing of temperature changes, the dual-function graphics display including graphics elements formed by a thermochromic ink composition having (1) a first state that is an opaque color at room temperature, (2) a second state that reacts to the higher temperature and changes to an opaque color different from the color associated with the first state, and (3) a third state that reacts to the lower temperature and changes to an opaque color different from the colors associated with the first and second states.

11. The dual-function display of claim 10 in which the graphics image is formed by a blended thermochromic ink composition.
